(19) United States
(12) Patent Application Publication
(10) Pub. No.: US 2016/0138263 A1
(43) Pub. Date: May 19, 2016

(54) DAMPING DEVICE

(71) Applicant: ASAHI KASEI HOMES CORPORATION, Shinjuku-ku, Tokyo (JP)

(72) Inventor: Masato KOYAMA, Tokyo (JP)

(73) Assignee: ASAHI KASEI HOMES CORPORATION, Shinjuku-ku, Tokyo (JP)

(21) Appl. No.: 14/902,975

(22) PCT Filed: Jul. 7, 2014
(86) PCT No.: PCT/JP2014/068066

§ 371 Date: Jan. 5, 2016

(30) Foreign Application Priority Data
Jul. 9, 2013 (JP) 2013-143544

(51) Int. Cl. E04B 1/98; F16F 15/02; E04H 9/02

(52) U.S. Cl. CPC E04B 1/98; E04H 9/02; F16F 15/02; E04H 2009/026

(57) ABSTRACT

A damping device includes a first member to be fixed to one of the horizontal members and protruding toward the other horizontal member, a second member to be fixed to the other horizontal member having a flexural rigidity smaller than the flexural rigidity of the one horizontal member and protruding toward the one horizontal member, and attenuation means coupled to the First member and to the second member. The attenuation means is provided closer to the other horizontal member.

### TECHNICAL FIELD

The present invention relates to a damping device for buildings such as single-family houses or low-rise housing complexes.

### BACKGROUND ART

A known example of damping devices of this type is disclosed in Patent Literature 1. This damping device includes a panel-shaped upper transmitting member fixed to a beam, a panel-shaped lower transmitting member fixed to a foundation such as a floor, and a hydraulic damper provided between the upper transmitting member and the lower transmitting member. The upper transmitting member and the lower transmitting member transmit vibration in the horizontal direction. The cylinder end and the piston rod end of the hydraulic damper are coupled to the upper transmitting member and the lower transmitting member, respectively.

### CITATION LIST

### Patent Literature

[Patent Literature 1] Japanese Unexamined Patent Publication No. 2002-70357A

### SUMMARY OF INVENTION

### Technical Problem

In the configuration in Patent Literature 1 above, the hydraulic damper is provided at the middle between the beam that is an upper horizontal member and the foundation that is a lower horizontal member. Unfortunately, for example, if the flexural rigidity of the upper beam is smaller than the flexural rigidity of the lower foundation, the upper beam is subjected to bending deformation, for example, due to reactive force or the like from the attenuation means during an earthquake or other events, and the attenuation performance of the hydraulic damper may not be sufficiently fulfilled.

An object of the present invention is to provide a damping device capable of sufficiently fulfilling the attenuation performance of attenuation means irrespective of the strength of a horizontal member such as a beam or a foundation.

### Solution to Problem

A damping device according to the present invention is to be provided between a pair of horizontal members extending in a horizontal direction and opposed to each other in a top-bottom direction. The damping device includes a first member configured to be fixed to one of the horizontal members and protruding toward the other horizontal member, a second member configured to be fixed to the other horizontal member having a flexural rigidity smaller than the flexural rigidity of the one horizontal member and protruding toward the one horizontal member, and attenuation means coupled to the first member and to the second member. The attenuation means is provided closer to the other horizontal member.

In this damping device, the attenuation means is provided closer to the other horizontal member having a smaller flexural rigidity of a pair of horizontal members. For this reason, when a horizontal force is applied to such a framework, the flexural stress from the attenuation means increases as the distance from the attenuation means increases. The horizontal member having a larger horizontal rigidity, therefore, can bear the flexural stress and can alleviate the load of reactive force on the other horizontal member. As a result, bending deformation of the horizontal member having a smaller flexural rigidity can be prevented or minimized. Since bending deformation of the horizontal member is prevented or minimized, the displacement of the framework as a whole can be concentrated on the attenuation means. The attenuation characteristics of the attenuation means thus can be sufficiently fulfilled irrespective of the strength of the horizontal member such as the beam or the foundation.

The first member may be shaped like a panel disposed along a direction in which the horizontal members extend, and may be joined to the one horizontal member. In this configuration, although the first member protrudes like a cantilever from the one horizontal member, the rigidity of the first member is enhanced because of its panel-like shape. The edge of the first member that is coupled to the attenuation means is displaced generally in the same manner as the relative displacement of the one horizontal member. As a result, the relative displacement between the first member and the attenuation means is increased, and the attenuation performance of the attenuation means thereby can be fulfilled more fully.

An end of the first member that is opposed to the other horizontal member may have a cut. The second member and the attenuation means may be disposed in the cut. In this configuration, since the second member and the attenuation means are disposed in this cut, size increase of the damping device in the width direction (that is, the direction in which the horizontal member extends) can be minimized.

The first member may include a plate-shaped web and a pair of flanges disposed on both sides of the web in the direction in which the horizontal members extend. The flanges may each have a width greater than the width of the web in an out-of-plane direction. The pair of flanges may be joined to the one horizontal member. In this configuration, the flexural rigidity of the first member is enhanced, so that the first member is less flexed by horizontal load, and the load can be transmitted to the hydraulic damper more reliably.

Each of the flanges may include an end plate shaped like a flat plate at an end thereof on the one horizontal member side. The end plate may be fixed to the one horizontal member in surface contact with the one horizontal member. Since the axial force (tensile force or compressive force) is transmitted between the flange and the one horizontal member through the end plate, the axial force can be transmitted smoothly.

Each of the flanges may include an end plate shaped like a flat plate at an end thereof on the one horizontal member side. The end plate may be rigidly joined to the one horizontal member in surface contact with the one horizontal member. Since the axial force (tensile force or compressive force) is transmitted between the flange and the one horizontal member through the end plate, the axial force can be transmitted more smoothly.

Each of the flanges may be formed in a tubular shape and have an opening at a side surface of the end on the one horizontal member side, the opening reaching the end plate. The end plate may have a through hole in communication with an interior space of the flange. An anchor bolt may be provided to be secured to the one horizontal member and inserted into the through hole. In this configuration, the end plate can be joined to the one horizontal member by means of an anchor bolt, so that rigid joint can be implemented suitably. Since the flange is rigidly joined to the one horizontal member immediately below the flange as described above, reduction in shear resistance at the end can be prevented or minimized while breakage in the web is avoided.

One of the flanges of the first member may have a protrusion protruding toward the other horizontal member relative to the other flange and the web. The second member may be provided to be opposed to the protrusion of the one flange. The attenuation means may be coupled to the protrusion of the one flange and to the second member. In this configuration, the attenuation means can be accommodated between the flanges of the first member, and the width of the damping device as a whole can be set equivalent to the width between the flanges.

The first member may be provided with a plate shaped like a flat plate fixed to ends of the other flange and the web on the other horizontal member side and extending to reach the one flange. This configuration can further enhance the rigidity of the end of the first member on the other horizontal member side. For example, buckling of the end of the first member on the other horizontal member side can be prevented when a horizontal force is applied.

A shaking stopper for preventing shaking of the first member in an out-of-plane direction may be provided between the first member and the other horizontal member or the second member. With this configuration, the shaking stopper can prevent deformation of the first member in the out-of-plane direction during an earthquake or other events and can prevent early damage of the damping device due to the deformation in the out-of-plane direction.

The shaking stopper may include a guide piece mounted on one of the first member and the other horizontal member or the second member and a restraining member mounted on the other to permit movement of the guide piece in the direction in which the other horizontal member extends and restrain movement in the out-of-plane direction. The engagement of the guide piece with the restraining member permits displacement of the first member in the in-plane direction (that is, the direction in which the other horizontal member extends) due to vibration during an earthquake or other events and prevents deformation or displacement in the out-of-plane direction.

The restraining member of the shaking stopper may include a pair of pinching pieces in intimate contact with both surfaces of the guide piece. The pair of pinching pieces may be set to a state in which movement of the guide piece in a direction in which the other horizontal member extends is restrained during environmental vibration and during a small earthquake, and movement of the guide piece in the direction in which the other horizontal member extends is permitted during a large earthquake. In this case, as for daily vibration such as environmental vibration (that is, small vibration), the restraining member is in intimate contact with the guide piece to prevent or minimize movement of the guide piece. The relative movement between the first member and the second member is therefore prevented or minimized, and the fulfillment of the function of the damping device is minimized for vibration to such a degree as environmental vibration. By contrast, during a large earthquake, movement (that is, swing) of the guide piece in the direction in which the other horizontal member extends is permitted, and the function of the damping device can be fulfilled.

The one horizontal member may be a concrete continuous foundation, and the other horizontal member may be a beam having a flexural rigidity smaller than the flexural rigidity of the continuous foundation. The attenuation means may be provided immediately below the beam. This configuration can reduce load on the beam that is the other horizontal member, leading to weight reduction or the like of the beam.

### Advantageous Effects of Invention

According to the present invention, the attenuation performance of the attenuation means can be sufficiently fulfilled irrespective of the strength of a horizontal member such as a beam or a foundation.

### BRIEF DESCRIPTION OF DRAWINGS

FIG. 1 is a front view of a framework provided with a damping device according to an embodiment of the present invention.

FIG. 2 is a front view of the damping device in FIG. 1.

FIG. 3 is a front view of a first member included in the damping device in FIG. 2.

FIG. 4 is a cross-sectional view taken along the line IV-IV in FIG. 2.

FIG. 5 is a cross-sectional view taken along the line V-V in FIG.

FIG. 6 is a cross-sectional view taken along the line VI-VI in FIG. 2.

### DESCRIPTION OF EMBODIMENTS

An embodiment of the present invention will be described below with reference to the drawings.

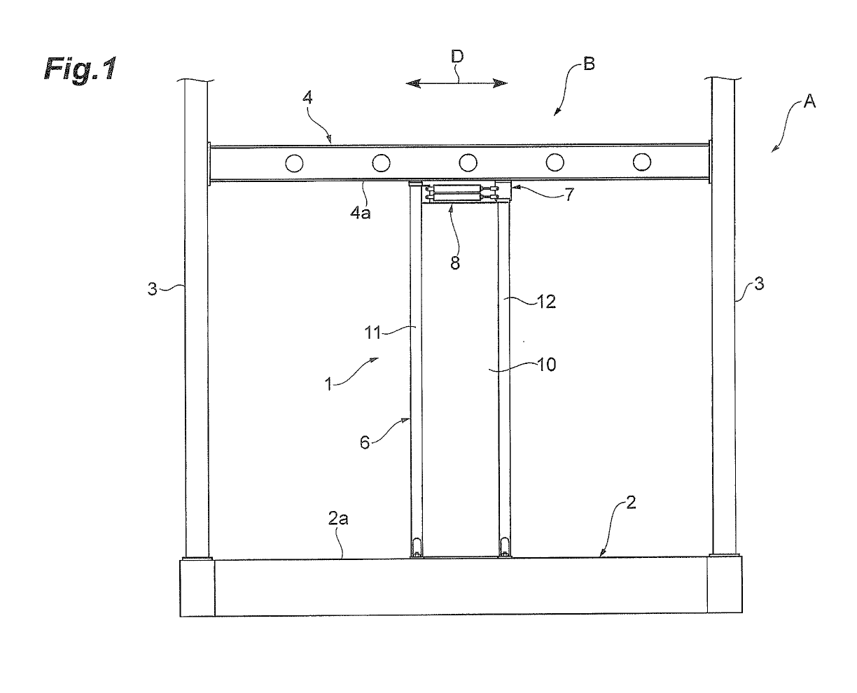

As illustrated in FIG. 1, a damping device 1 of the present embodiment is a device provided in, for example, a building having a steel framework A for effectively attenuating vibration, for example, when vibration occurs in the building due to an earthquake or other events. Examples of the buildings provided with the damping device 1 include single-family houses, low-rise housing complexes, and the like. Although the damping device 1 is provided on the first-floor of a building in the example described below, the damping device 1 may be provided on the second floor or any higher level of a building.

The framework A has a rigid-frame structure and includes a concrete continuous foundation 2 extending in a horizontal direction D, a pair of columns 3 and 3 spaced apart from each other by a predetermined distance in the horizontal direction D and standing on the continuous foundation 2, and a beam 4 installed between the columns 3 and 3. The continuous foundation 2 and the beam 4 are a pair of horizontal members. The damping device 1 is built in the framework A to form a damping structure B. The skeleton on which the damping device 1 is provided may be constructed by a continuous column joint process as is the case with the framework A or may be constructed by a continuous beam joint process.

The continuous foundation 2, which is one of the horizontal members, is, for example, a continuous footing. The columns 3 and 3 are formed with, for example, steel square tubes. The beam 4, which is the other horizontal member, is formed with, for example, an H beam. Both ends of the beam 4 are joined to the columns 3 and 3. The continuous foundation 2 and the beam 4 extend in parallel with each other so as to be opposed to each other in the top-bottom direction. That is, the continuous foundation 2 and the beam 4 extend in the same direction, that is, the horizontal direction D. The flexural rigidity of the continuous foundation 2 is greater than the flexural rigidity of the beam 4. That is, the beam 4 has a flexural rigidity smaller than that of the continuous foundation 2. The beam 4 has the property of flexing more easily than the continuous foundation 2 when a moment is exerted in a vertical plane including the continuous foundation 2 and the beam 4. As described above, in the present embodiment, the flexural rigidity refers to inflexibility of each member when a moment exerted in the vertical plane including the strong axis of the member acts on the member.

The damping structure B is configured to include the continuous foundation 2, the columns 3 and 3, the beam 4, and the damping device 1.

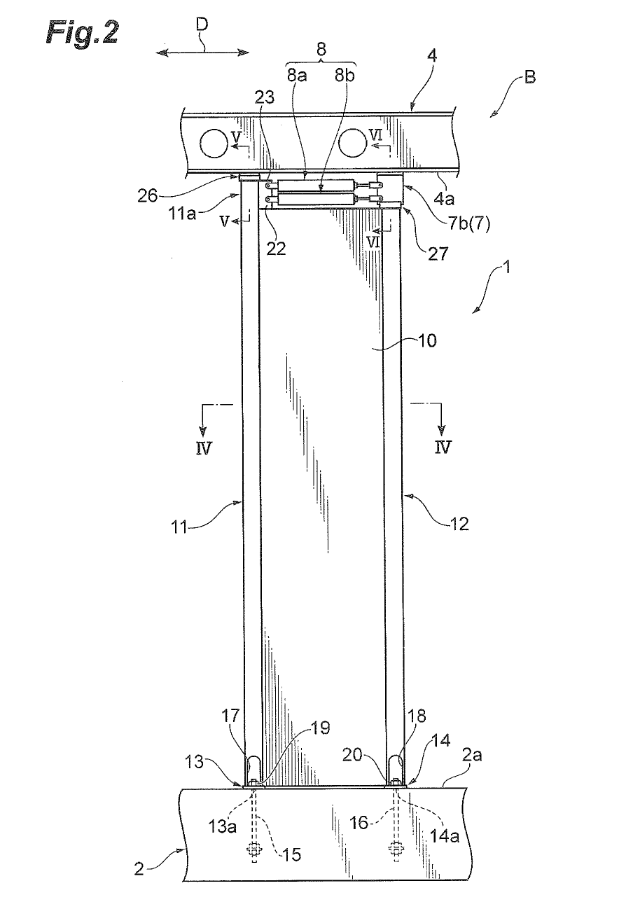

As illustrated in FIG. 1 and FIG. 2, the damping device 1 is provided between the continuous foundation 2 and the beam 4. More specifically, the damping device 1 is shaped like a panel disposed along the horizontal direction D and the vertical direction. That is, the damping device 1 is a load-bearing panel disposed in the plane formed with the continuous foundation 2, the columns 3 and 3, and the beam 4.

The damping device 1 includes a first member 6 standing on a top surface 2a of the continuous foundation 2 and protruding upward, and a second member 7 fixed to and suspended from a flange 4a that is a lower part of the beam 4. In other words, the damping device 1 includes the first member 6 fixed to the continuous foundation 2 and protruding toward the beam 4, and the second member 7 fixed to the beam 4 and protruding toward the continuous foundation 2.

The upper end of the first member 6 is coupled to the beam 4 and the second member 7 with shaking stoppers 26 and 27 interposed as will be described later, but is not completely fixed to the beam 4 and the second member 7. More specifically, the first member 6 is not structurally coupled to the beam 4 and does not bear the axial force from the beam 4.

The upper end of the first member 6 can slide in the horizontal direction D relative to the beam 4 and the second member 7. In other words, although the first member 6 does not bear the axial force, displacement in the horizontal direction D may occur between the first member 6 and the beam 4 and between the first member 6 and the second member 7. An attenuation device (attenuation means) 8 coupled to the first member 6 and the second member 7 is provided between the upper end of the first member 6 and the second member 7.

First, referring to FIG. 1 to FIG. 3, the first member 6 and the joint structure of the first member 6 to the continuous foundation 2 will be described. The first member 6 includes a plate-shaped web 10 and a pair of flanges 11 and 12 disposed on both sides (both of the right and left sides) of the web 10 in the horizontal direction D. The web 10 is formed with a rectangular steel plate and extends along the horizontal direction D and the vertical direction. A pair of flanges 11 and 12 is configured with a first flange (one flange) 11 and a second flange (the other flange) 12 spaced apart from each other in the horizontal direction D.

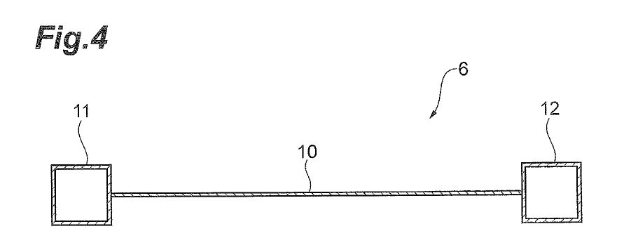

The first flange 11 and the second flange 12 are each formed with a steel square tube in a tubular shape. As illustrated in FIG. 4, the horizontal cross section of each of the flanges 11 and 12 is shaped like a square. The web 10 is joined to the respective side surfaces of the flanges 11 and 12, for example, by welding. The width of each of the flanges 11 and 12 in the out-of-plane direction (that is, the direction orthogonal to the web 10) is greater than the width in the out-of-plane direction (that is, the thickness) of the web 10. Having such a cross-sectional shape enhances the in-plane flexural strength of the first member 6 and makes the first member 6 less deformable.

The flanges 11 and 12 are rigidly joined to the continuous foundation 2, whereby the first member 6 is fixed to the continuous foundation 2. In the present embodiment, rigid joint refers to a state of having finite rigidity, in which although the rigidity is theoretically not perfect but finite, the value of the rigidity is large enough that when stress analysis is performed with a mathematical model for perfect rigidity, the analysis has a precision that does not pose any problem in practice. The flanges 11 and 12 have flat plate-shaped end plates 13 and 14, respectively, at the lower ends thereof (that is, the ends on the continuous foundation 2 side). The end plates 13 and 14 are welded to the respective lower ends of the flanges 11 and 12 so as to close the respective openings at the bottom of the flanges 11 and 12.

At the approximately center of the end plates 13 and 14, through holes 13a and 14a are provided, respectively, in communication with the space inside the end plates 13 and 14. Anchor bolts 15 and 16 secured to the continuous foundation 2 to stand thereon are inserted into the through holes 13a and 14a and screwed into nuts 19 and 20, whereby the first member 6 is joined to the continuous foundation 2. That is, the flanges 11 and 12 are rigidly joined to the continuous foundation 2 in a state in which the end plates 13 and 14 at the lower ends are in surface contact with the top surface 2a of the continuous foundation 2.

The flanges 11 and 12 have openings 17 and 18, each shaped like a slot elongated in the vertical direction, at one side surfaces of the respective lower ends (that is, the ends on the continuous foundation 2 side). The openings 17 and 18 are each formed in such a size that allows insertion of the average adult hand. The respective lower ends of the openings 17 and 18 reach the end plates 13 and 14. The end plates 13 and 14 are formed so that the nuts 19 and 20 can be screwed on the anchor bolts 15 and 16 inserted into the through holes 13a and 14a of the end plates 13 and 14, respectively, thereby facilitating joints with anchor bolts.

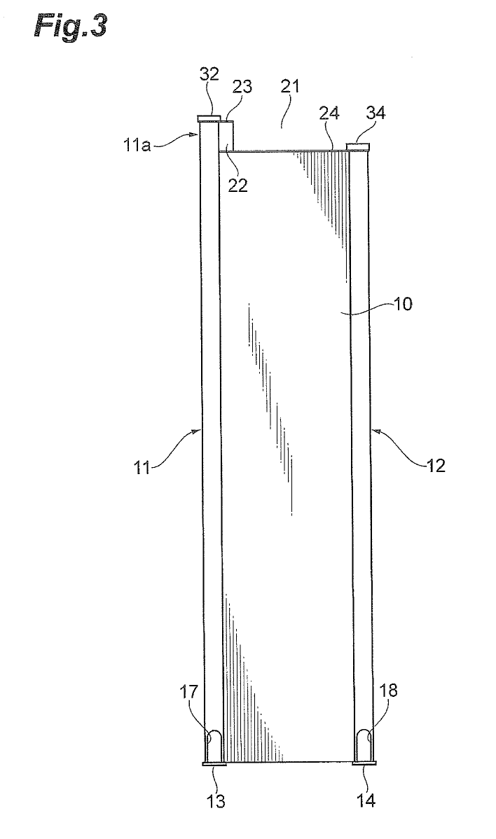

Referring to FIG. 2 and FIG. 3, a configuration of the upper part of the damping device 1 will be described. As illustrated in FIG. 2 and FIG. 3, the first flange 11 of the first member 6 has a protrusion 11a protruding above the second flange 12 and the web 10. That is, the upper portion of the first flange 11 protrudes toward the beam 4 relative to the upper ends of the second flange 12 and the web 10. In this configuration, the upper end (that is, the end opposed to the beam 4) of the first member 6 has a rectangular cut 21.

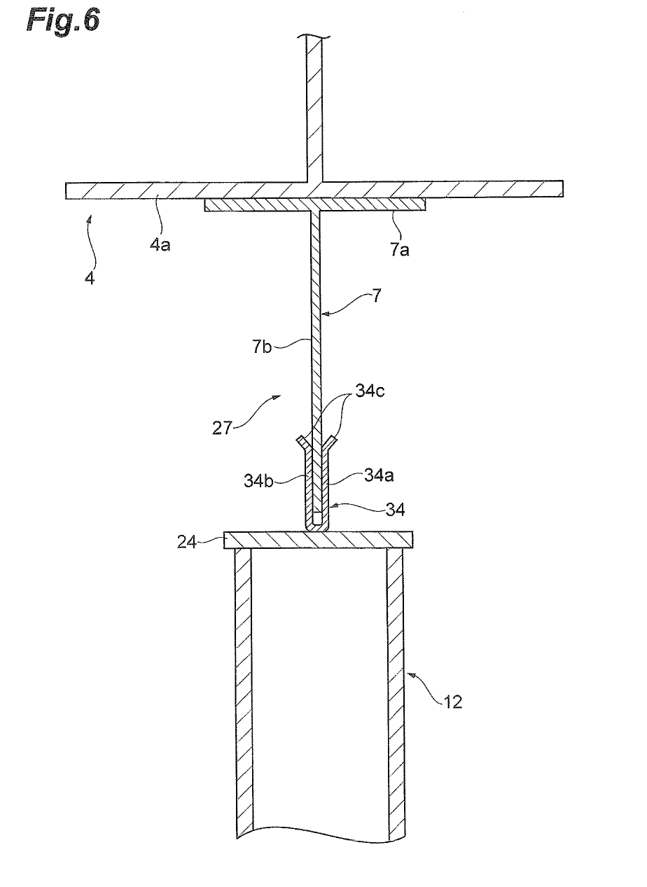

The second member 7 is provided to be opposed to the protrusion 11a of the first flange 11 (see FIG. 2). The second member 7 is, for example, a T-shaped steel plate member and has a mounting plate portion 7a fixed to the flange 4a of the beam 4 and a suspended plate portion 7b vertically joined to the mounting plate portion 7a (see FIG. 6). The protrusion 11a of the first flange 11 is provided with a plate 22 protruding toward the second member 7. The plate 22 is fixed to a side surface of the protrusion 11a, for example, by welding and is disposed on the same plane as the web 10. A plate 23 shaped like a flat plate is fixed to the upper end of the first flange 11, for example, by welding so as to close the opening at the top of the first flange 11. The plate 23 is disposed horizontally and extends toward the second member 7 to the same extent as the protruding length of the plate 22 in the horizontal direction D.

The first member 6 is provided with a reinforcing plate (plate) 24 shaped like a flat plate fixed to the upper ends of the second flange 12 and the web 10 (that is, the ends on the beam 4 side). The reinforcing plate 24 is fixed, for example, by welding so as to close the opening at the top of the second flange 12. The reinforcing plate 24 is disposed horizontally and extends to reach the first flange 11.

The upper end of the plate 22 provided on the protrusion 11a is joined to the bottom surface of the plate 23, for example, by welding. The lower end of the plate 22 is joined to the top surface of the reinforcing plate 24, for example, by welding.

The attenuation device 8 described above is coupled to the protrusion 11a of the first flange 11 and to the second member 7. More specifically, the attenuation device 8 has two hydraulic dampers 8a and 8b (see FIG. 2). The hydraulic dampers 8a and 8b are disposed so as to be able to be extended and retracted in the horizontal direction D. The hydraulic dampers 8a and 8b are disposed next to each other in the top-bottom direction. The cylinder-side end (one end on the left side in the figure) of each of the hydraulic dampers 8a and 8b is coupled to the plate 23. The piston rod-side end (the other end on the right side in the figure) of each of the hydraulic dampers 8a and 8b is coupled to the second member 7.

As described above, the attenuation device 8 is provided between the protrusion 11a of the first member 6 and the second member 7. In other words, the attenuation device 8 is provided such that the attenuation device 8 and the second member 7 are disposed in the cut 21 formed at the upper end of the first flange 11.

As illustrated in FIG. 1 and FIG. 2, the attenuation device 8 is provided closer to the beam 4. More specifically, the attenuation device 8 is provided immediately below the beam 4. As described above, the attenuation device 8 is provided in proximity to the beam 4 having a flexural rigidity smaller than the flexural rigidity of the continuous foundation 2 to achieve more effective attenuation effects.

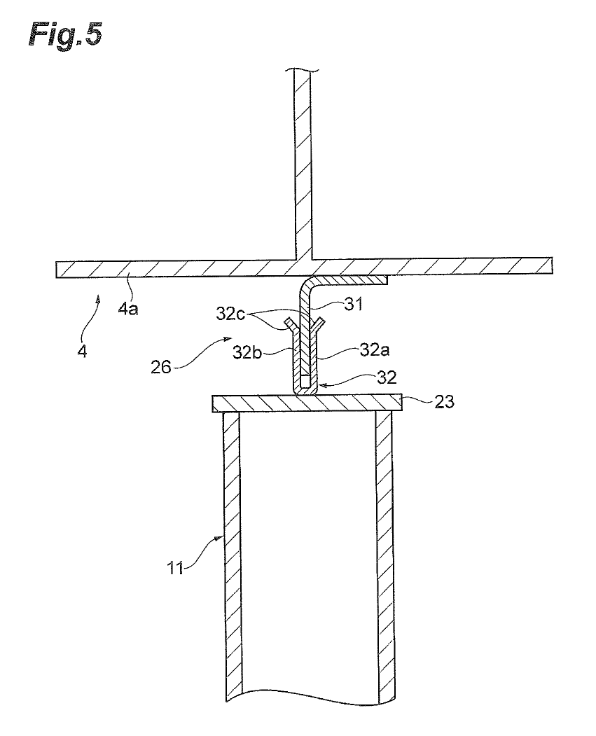

As illustrated in FIG. 2, FIG. 5, and FIG. 6, the shaking stoppers 26 and 27 are provided between the first member 6 and the beam 4 and between the first member 6 and the second member 7, respectively, for preventing shaking of the first member 6 in the out-of-plane direction (the vertical direction on the drawing sheet of FIG. 2, the right-left direction in FIG. 5 and FIG. 6).

The shaking stopper 26 provided between the first member 6 and the beam 4 includes a guide piece 31 mounted on the flange 4a of the beam 4 and a restraining member 32 mounted on the first flange 11 of the first member 6 for restraining movement of the guide piece 31 in the out-of-plane direction (the right-left direction in FIG. 5). More specifically, the restraining member 32 is a member having U-shaped cross section. The folded portion of the U shape that is at the lower end is joined to the plate 23 provided on the upper end of the first flange 11, for example, by welding. The restraining member 32 has spring characteristics and includes a pair of pinching pieces 32a and 32b in intimate contact with both surfaces of the guide piece 31. The pinching pieces 32a and 32b may be in intimate surface contact with the guide piece 31 or may be in intimate line contact. The open upper ends 32c and 32c of the restraining member 32 are widened approximately in the shape of V (that is, the gap increases upward) to facilitate insertion of the guide piece 31 into the restraining member 32.

The shaking stopper 27 provided between the first member 6 and the second member 7 includes the suspended plate portion 7b of the second member 7 functioning as a guide piece and a restraining member 34 mounted on the second flange 12 of the first member 6 for restraining movement of the suspended plate portion 7b in the out-of-plane direction (the right-left direction in FIG. 6). More specifically, the restraining member 34 is a member having U-shaped cross section. The folded portion of the U shape that is at the lower end is joined to the reinforcing plate 24 provided on the upper end of the second flange 12, for example, by welding. The restraining member 34 has spring characteristics and includes a pair of pinching pieces 34a and 34b in intimate contact with both surfaces of the suspended plate portion 7b. The pinching pieces 34a and 34b may be in intimate surface contact with the suspended plate portion 7b or may be in intimate line contact. The open upper ends 34c and 34c of the restraining member 34 are widened approximately in the shape of V (that is, the gap increases upward) to facilitate insertion of the suspended plate portion 7b into the restraining member 34.

As described above, the second member 7 is connected to the attenuation device 8 and have the function of transmitting displacement of the beam 4 to the attenuation device 8 with the function of the guide piece of the shaking stopper 27.

The static friction between the restraining member 32, 34 and the guide piece 31, 7b is defined based on the expression (1) below:

f=F/N>δ×Kp (1)

where f is static friction (kN) between the pinching piece and the guide piece; N is the number of places in the guide piece pinched by the restraining member; F is static friction (kN) in the shaking stopper as a whole; δ is a permissible displacement (cm) of a pair of horizontal members during environmental vibration; and Kp is rigidity of the first member (kN/cm).

Examples of specific values are as follows:

f: 0.75 to 1.25 KN

δ: 0.03 to 0.05 cm (0.3 to 0.5 mm)

Kp: 15 to 30 kN/cm.

The number of places pinched are, in total, four: pinching of the guide piece 31 by the pinching piece 32a and by the pinching piece 32b, and pinching of the suspended plate portion 7b by the pinching piece 34a and by the pinching piece 34b.

For example, letting Kp be 30 and δ be 0.05, then f>1 kN. The static friction F in the shaking stoppers 26 and 27 as a whole is written as F>1 kN×4=4 kN.

The elasticity and others of the restraining members 32 and 34 are set as described above, so that a pair of pinching pieces 32a and 32b in the shaking stopper 26 is set to a state in which movement of the guide piece 31 in the direction in which the beam 4 extends (that is, the horizontal direction D) is restrained during environmental vibration and during a small earthquake. By contrast, a pair of pinching pieces 32a and 32b is set to a state in which movement of the guide piece 31 in the direction in which the beam 4 extends (that is, the horizontal direction D) is permitted during a large earthquake.

The elasticity and others of the restraining member 34 are set as described above, so that a pair of pinching pieces 34a and 34b in the shaking stopper 27 is set to a state in which movement of the suspended plate portion 7b in the direction in which the beam 4 extends (that is, the horizontal direction D) is restrained during environmental vibration and during a small earthquake. By contrast, a pair of pinching pieces 34a and 34b is set to a state in which movement of the suspended plate portion 7b in the direction in which the beam 4 extends (that is, the horizontal direction D) is permitted during a large earthquake.

With the configuration as described above, the upper part of the damping device 1 is joined to the beam 4 with a vertical roller joint that transmits a force in the horizontal direction from the beam 4 but does not transmit a force in the vertical direction.

In the damping device 1 described above, the attenuation device 8 is provided closer to the beam 4 having a smaller flexural rigidity of a pair of horizontal members, namely, the continuous foundation 2 and the beam 4. For this reason, when a horizontal force is applied to the framework A, the flexural stress from the attenuation device 8 increases as the distance from the attenuation device 8 increases. The continuous foundation 2, which is a horizontal member having a larger horizontal rigidity, therefore, can bear the flexural stress and can alleviate the load of reactive force on the beam 4. As a result, bending deformation of the beam 4 having a smaller flexural rigidity can be prevented or minimized. Since bending deformation of the beam 4 is prevented or minimized, the displacement of the framework A as a whole can be concentrated on the attenuation device 8. The attenuation characteristics of the attenuation device 8 thus can be sufficiently fulfilled irrespective of the strength of the horizontal member such as the beam 4 or the continuous foundation 2.

Although the first member 6 protrudes like a cantilever with the base end rigidly joined to the continuous foundation 2, the rigidity of the first member is enhanced because of its panel-like shape. The edge of the first member 6 coupled to the attenuation device 8 is displaced generally in the same manner as the relative displacement of the continuous foundation 2. As a result, the relative displacement between the first member 6 and the attenuation device 8 is increased, and the attenuation performance of the attenuation device 8 thereby can be fulfilled more fully.

Since the second member 7 and the attenuation device 8 are disposed in the cut 21 formed at the upper end of the first member 6, size increase of the damping device 1 in the width direction (that is, the horizontal direction D) can be minimized.

Since a pair of flanges 11 and 12 is rigidly joined to the continuous foundation 2, the flexural rigidity of the first member 6 is enhanced. The first member 6 is therefore less flexed by horizontal load and makes a horizontal movement more integrally with the continuous foundation 2. The load is thus transmitted to the hydraulic dampers 8a and 8b more reliably.

Since the axial force (tensile force or compressive force) is transmitted between the flanges 11 and 12 and the continuous foundation 2 through the end plates 13 and 14, the axial force can be transmitted more smoothly.

The openings 17 and 18 formed at the lower ends of the flanges 11 and 12 enable the end plates 13 and 14 to be joined to the continuous foundation 2 by means of anchor bolts. Rigid joint is thus suitably implemented. Since the flanges 11 and 12 are rigidly joined to the continuous foundation 2 immediately below the flanges 11 and 12 as described above, reduction in shear strength at the end can be prevented or minimized while breakage in the web 10 can be avoided.

Since the attenuation device 8 is coupled to the protrusion 11a of the first flange 11 and to the second member 7, the attenuation device 8 can be accommodated between the flanges 11 and 12 of the first member 6, and the width of the damping device 1 as a whole can be set equivalent to the width between the flanges 11 and 12. The flange 11, which receives the attenuation device 8, is sufficiently resistant against the compressive force or tensile force of the attenuation device 8.

The first member 6 is provided with the reinforcing plate 24 shaped like a flat plate fixed to the ends of the second flange 12 and the web 10 on the beam 4 side and extending to reach the first flange 11. This configuration can further enhance the rigidity of the upper end of the first member 6. For example, buckling of the end of the first member 6 on the beam 4 side can be prevented when a horizontal force is applied.

The shaking stoppers 26 and 27 are provided between the first member 6 and the beam 4 and between the first member 6 and the second member 7, respectively, for preventing shaking of the first member 6 in the out-of-plane direction. This configuration can prevent deformation of the first member 6 in the out-of-plane direction during an earthquake or other events and can prevent early damage of the damping device 1 due to the deformation in the out-of-plane direction.

In the shaking stoppers 26 and 27, the engagement of the guide piece 31 with the restraining member 32 and the engagement of the second member 7 with the restraining member 34 permit displacement of the first member 6 in the in-plane direction (that is, the direction in which the beam 4 extends) due to vibration during an earthquake or other events while preventing deformation or displacement in the out-of-plane direction.

The pinching piece pairs 32a, 32b and 34a, 34b in the restraining members 32 and 34 are set to a state in which movement of the guide piece 31 and the suspended plate portion 7b in the direction in which the beam 4 extends is restrained during environmental vibration and during a small earthquake, and movement of the guide piece 31 and the suspended plate portion 7b in the direction in which the beam 4 extends is permitted during a large earthquake. As for daily vibration (that is, small vibration) such as environmental vibration, the restraining members 32 and 34 are in intimate contact with the guide piece 31 and the suspended plate portion 7b, respectively, to prevent or minimize movement of the guide piece 31 and the suspended plate portion 7b. The relative movement between the first member 6 and the second member 7 is thus prevented or minimized, so that the fulfillment of the function of the damping device 1 is minimized for vibration to such a degree as environmental vibration. By contrast, during a large earthquake, movement (that is, swing) of the guide piece 31 and the suspended plate portion 7b in the direction in which the beam 4 extends is permitted, so that the function of the damping device 1 can be fulfilled.

One of the horizontal members is the concrete continuous foundation 2 and the other horizontal member is the beam 4 having a flexural rigidity smaller than the flexural rigidity of the continuous foundation 2. Since the attenuation device 8 is provided immediately below the beam 4, the load on the beam 4 can be reduced, leading to weight reduction of the beam 4.

Since the hydraulic dampers 8a and 8b are employed as the attenuation device 8, attenuation force in proportion to the deformation speed of the framework A can be obtained, and more suitable damping effects can be obtained.

The first member 6 and the second member 7 have a simple structure, which contributes to reduction in production steps, for example, by using general-purpose products or by fabricating the flanges 11 and 12 simply by folding a steel plate. The costs are thus reduced.

The vertical roller joint of the upper part of the damping device 1 to the beam 4 facilitates structural calculation. For example, even when the damping device 1 is installed, it is unnecessary to incorporate another axial force into calculation and to change the calculation model. As described above, the damping device 1 contributes design merits.

Although an embodiment of the present invention has been described above, the present invention should not be construed to be limited to the foregoing embodiment. For example, the position in top-bottom direction of the attenuation device 8 between the continuous foundation 2 and the beam 4 can be changed as appropriate. The height at which the attenuation device 8 is provided can be adjusted in accordance with the degree of difference in flexural rigidity between the upper horizontal member and the lower horizontal member.

When the damping device 1 is provided on a higher floor, the upper and lower horizontal members are both steel beams. If the upper beam has a greater flexural rigidity of the upper and lower beams, the attenuation means may be provided immediately above the lower beam.

The shaking stopper may be provided between the first member 6 and one of the continuous foundation 2 and the second member 7, rather than the shaking stoppers 26 and 27 being provided between the first member 6 and the continuous foundation 2 and between the first member 6 and the second member 7.

The web 10 of the first member 6 may not be shaped like a flat plate but may be configured to have a plurality of through holes. The flat plate may have an advertisement thereon. When the flat plate is elaborately designed, the wall of the building may be formed with, for example, a transparent member to expose or visualize the design. The flanges 11 and 12 of the first member 6 may be shaped in flat plates orthogonal to the web 10, rather than steel square tubes. That is, the first member 6 as a whole may have the same configuration as an H beam.

The attenuation means may be configured with elements, for example, such as friction dampers or viscoelastic dampers, rather than hydraulic dampers.

### REFERENCE SIGNS LIST

1 . . . Damping device, 2 . . . Continuous foundation (one horizontal member), 4 . . . Beam (the other horizontal member), 6 . . . First member, 7 . . . Second member, 7b . . . Suspended plate portion (guide piece), 8 . . . Attenuation device (attenuation means), 10 . . . Web, 11 . . . First flange (one flange), 12 . . . Second flange (the other flange), 13, 14 . . . End plate, 13a, 14a . . . Through hole, 15, 16 . . . Anchor bolt, 17, 18 . . . Opening, 21 . . . Cut, 24 . . . Reinforcing plate (plate), 26, 27 . . . Shaking stopper, 31 . . . Guide piece, 32 . . . Restraining member, 32a, 32b . . . Pinching piece, 34 . . . Restraining member, 34a, 34b . . . Pinching piece, B . . . Damping structure, D . . . Horizontal direction.

1. A damping device to be provided between a pair of horizontal members that are extending in a horizontal direction and opposed to each other in a top-bottom direction, the damping device comprising:
a first member fixed to one of the horizontal members and protruding toward the other horizontal member;
a second member fixed to the other horizontal member having a flexural rigidity smaller than a flexural rigidity of the one horizontal member and protruding toward the one horizontal member; and
attenuation means coupled to the first member and to the second member, wherein
the attenuation means is provided closer to the other horizontal member.

2. The damping device according to claim 1, wherein
the first member is shaped like a panel disposed along a direction in which the horizontal members extend, and is joined to the one horizontal member.

3. The damping device according to claim 2, wherein
an end of the first member that is opposed to the other horizontal member has a cut, and
the second member and the attenuation means are disposed in the cut.

4. The damping device according to claim 2, wherein
the first member includes a plate-shaped web and a pair of flanges disposed on both sides of the web in the direction in which the horizontal members extend,
the flanges each have a width greater than a width of the web in an out-of-plane direction, and
the pair of flanges is joined to the one horizontal member.

5. The damping device according to claim 4, wherein
each of the flanges includes an end plate shaped like a flat plate at an end thereof on the one horizontal member side, and
the end plate is fixed to the one horizontal member in surface contact with the one horizontal member.

6. The damping device according to claim 5, wherein
each of the flanges includes an end plate shaped like a flat plate at an end thereof on the one horizontal member side, and
the end plate is rigidly joined to the one horizontal member in surface contact with the one horizontal member.

7. The damping device according to claim 6, wherein
each of the flanges is formed in a tubular shape and has an opening at a side surface of the end on the one horizontal member side, the opening reaching the end plate,
the end plate has a through hole in communication with an interior space of the flange, and
an anchor bolt is provided to be secured to the one horizontal member and inserted into the through hole.

8. The damping device according to claim 4, wherein
one of the flanges of the first member has a protrusion protruding toward the other horizontal member relative to the other flange and the web,
the second member is provided to be opposed to the protrusion of the one flange, and
the attenuation means is coupled to the protrusion of the one flange and to the second member.

9. The damping device according to claim 8, wherein
the first member is provided with a plate shaped like a flat plate fixed to ends of the other flange and the web on the other horizontal member side and extending to reach the one flange.

10. The damping device according to claim 1, wherein
a shaking stopper for preventing shaking of the first member in an out-of-plane direction is provided between the first member and the other horizontal member or the second member.

11. The damping device according to claim 10, wherein
the shaking stopper includes a guide piece mounted on one of the first member and the other horizontal member or the second member and a restraining member mounted on the other to permit movement of the guide piece in the direction in which the other horizontal member extends and restrain movement in the out-of-plane direction.

12. The damping device according to claim 11, wherein
the restraining member of the shaking stopper includes a pair of pinching pieces in intimate contact with both surfaces of the guide piece, and
the pair of pinching pieces is set to a state in which movement of the guide piece in a direction in which the other horizontal member extends is restrained during environmental vibration and during a small earthquake, and movement of the guide piece in the direction in which the other horizontal member extends is permitted during a large earthquake.

13. The damping device according to claim 1, wherein
the one horizontal member is a concrete continuous foundation, and the other horizontal member is a beam having a flexural rigidity smaller than a flexural rigidity of the continuous foundation, and
the attenuation means is provided immediately below the beam.
